(19) United States
(12) Patent Application Publication
(10) Pub. No.: US 2026/0092724 A1
(43) Pub. Date: Apr. 2, 2026

(54) CARBON-CAPTURE COOLING SYSTEM

(71) Applicant: Tree Associates Ltd., Norwich (GB)

(72) Inventor: Bernard Richard KILLINGBECK, Norwich (GB)

(21) Appl. No.: 19/124,384

(22) PCT Filed: Sep. 25, 2023
(86) PCT No.: PCT/GB2023/052475

§ 371 Date: Apr. 25, 2025

(30) Foreign Application Priority Data
Oct. 26, 2022 (GB) 2215831.5

(51) Int. Cl. F25B 9/00; F01D 15/10; F25B 9/06; F25J 3/06; H02K 7/18

(52) U.S. Cl. CPC F25B 9/008; F01D 15/10; F25B 9/06; F25J 3/067; F25J 3/0695; H02K 7/1823; F05D 2220/76; F25B 2400/14; F25J 2270/80

(57) ABSTRACT

A carbon-capture cooling system comprises: a refrigeration system comprising an evaporator and arranged to supply a liquid refrigerant to the evaporator, an air compressor arranged to compress air including gaseous carbon dioxide; and a compressed air storage vessel arranged to receive the compressed air from the air compressor and comprising an air outlet. The evaporator is arranged to extract heat from the compressed air in the compressed air storage vessel by evaporation of the liquid refrigerant, thereby to cool the compressed air to liquidise the gaseous carbon dioxide for capture. The air outlet is arranged to release the cooled compressed air from the compressed air storage vessel for cooling an external environment of the carbon-capture cooling system.

### RELATED APPLICATIONS

The present application is a national stage application under 35 U.S.C. § 371 of International Application No. PCT/GB2023/052475, filed Sep. 25, 2023, which claims priority to Great Britain Patent Application No. 2215831.5, filed Oct. 26, 2022. The above referenced applications are hereby incorporated by reference.

### FIELD OF THE INVENTION

The present invention relates to a carbon-capture cooling system.

### BACKGROUND

Each year, human activities release more carbon dioxide (CO2) into the atmosphere than natural processes can remove, causing the amount of carbon dioxide in the atmosphere to increase. Due to the greenhouse effect, this increase of carbon dioxide in the atmosphere is causing global temperatures to rise. This is felt acutely in densely populated cities, where buildings, roads, and other expanses of concrete tend to retain heat.

Attempts have been made to capture and store carbon dioxide before it enters the atmosphere. The CO2 is usually captured from a large production source, such as a chemical plant or a biomass power plant, and then stored in an underground geological formation. The aim is to prevent the release of CO2 from heavy industry with the intent of mitigating the effects of climate change. There is however a risk that some CO2 might leak into the atmosphere over a long period of time. Purpose-built systems for extracting CO2 from air have also been constructed, but the lower concentration of CO2 in air compared to combustion sources complicates the engineering and leads to higher costs. There is also still a problem of how to securely store the CO2 once it has been captured.

The present invention aims to address these problems of carbon capture and global warming.

### SUMMARY OF INVENTION

According to an aspect of the invention, there is provided a carbon-capture cooling system, comprising: a refrigeration system comprising an evaporator and arranged to supply a liquid refrigerant to the evaporator; an air compressor arranged to compress air including gaseous carbon dioxide; and a compressed air storage vessel arranged to receive the compressed air from the air compressor and comprising an air outlet; wherein: the evaporator is arranged to extract heat from the compressed air in the compressed air storage vessel by evaporation of the liquid refrigerant, thereby to cool the compressed air to liquidise the gaseous carbon dioxide for capture; and the air outlet is arranged to release the cooled compressed air from the compressed air storage vessel for cooling an external environment of the carbon-capture cooling system.

The invention advantageously captures carbon dioxide (CO2) from the air while providing a cooling effect on the external environment, such as a room in a building or a built-up urban area. That is, the claimed system functions efficiently as both a carbon-capture system and an air conditioning system. Putting refrigerated air back into built-up areas such as towns/cities, major road, airports, and the like, helps to reduce retained heat in these areas. This heat is a major contribution to climate change that tends to be neglected by the usual measures taken to tackle global warming.

Furthermore, the captured liquid carbon dioxide may be utilised in a variety of industrial applications, for example as a refrigerant for preserving chilled foods, or for carbonation of beverages.

The air entering the carbon-capture cooling system may comprise a high concentration of CO2, for example in the case of an exhaust gas from a coal/gas fired power plant/blast furnace, gasoline or diesel internal combustion engine, or other industrial process.

The carbon-capture cooling system can go straight to liquid CO2, whereas known chemical carbon capture does not. The inventive system also does not need water, while an Armine (chemical carbon capture) system may need about 2.9 times the process water of a power plant.

The refrigeration system may comprise: a refrigerant compressor arranged to receive evaporated refrigerant gas from the evaporator and to compress the refrigerant gas; and a refrigerant gas cooler and expander system arranged to receive the compressed refrigerant gas from the refrigerant compressor and to liquify the compressed refrigerant gas to supply the liquid refrigerant to the evaporator.

The refrigerant gas cooler and expander system may comprise: a refrigerant gas cooler arranged to receive the compressed refrigerant gas from the refrigerant compressor and to cool the compressed refrigerant gas; and a refrigerant turbine arranged to receive the cooled compressed refrigerant gas from the refrigerant gas cooler and to expand the compressed refrigerant gas, thereby to liquify the compressed refrigerant gas to supply the liquid refrigerant to the evaporator.

The refrigerant gas cooler and expander system may comprise a refrigerant turbine arranged to receive the compressed refrigerant gas from the refrigerant compressor and to cool and expand the compressed refrigerant gas, thereby to liquify the compressed refrigerant gas to supply the liquid refrigerant to the evaporator.

The refrigerant turbine may comprise a boundary layer turbine.

The carbon-capture cooling system may comprise an electrical generator connected to the refrigerant turbine for generating electrical power.

The electrical generator connected to the refrigerant turbine may be arranged to generate electrical power for driving the refrigerant compressor.

The electrical generator connected to the refrigerant turbine may be arranged to generate electrical power at 400 Hz.

The carbon-capture cooling system may comprise an air turbine arranged to receive the cooled compressed air from the outlet of the compressed air storage vessel and to expand the cooled compressed air for cooling the external environment of the carbon-capture cooling system.

The air turbine may comprise a boundary layer turbine.

The carbon-capture cooling system may comprise an electrical generator connected to the air turbine for generating electrical power.

The electrical generator connected to the air turbine may be arranged to generate electrical power for driving the air compressor.

The electrical generator connected to the air turbine may be arranged to generate electrical power at 400 Hz.

The carbon-capture cooling system may comprise a filter for removing contaminants from the cooled compressed air.

The carbon-capture cooling system may comprise a carbon dioxide storage vessel arranged to receive the liquidised carbon dioxide.

The evaporator may be located at least partially inside the compressed air storage vessel.

The evaporator may be located entirely inside the compressed air storage vessel.

The refrigerant may comprise carbon dioxide.

According to another aspect of the invention, there is provided a carbon-capture cooling system, comprising: a refrigeration system comprising a plurality of evaporators and arranged to supply a liquid refrigerant to the evaporators; an air compressor arranged to compress air including gaseous carbon dioxide; and a plurality of compressed air storage vessels each comprising an air outlet; wherein: a first one of the compressed air storage vessels is arranged to receive the compressed air from the air compressor; a second one of the compressed air storage vessels is arranged to receive the compressed air from the air outlet of the first one of the compressed air storage vessels; a first one of the evaporators is arranged to extract heat from the compressed air in the first one of the compressed air storage vessels, and the second one of the evaporators is arranged to extract heat from the compressed air in the second one of the compressed air storage vessels, by evaporation of the liquid refrigerant, thereby to cool the compressed air to liquidise the gaseous carbon dioxide for capture; and the air outlet of the second compressed air storage vessel, or of a further compressed air storage vessel which is located downstream of the second compressed air storage vessel, is arranged to release the cooled compressed air from the second or further compressed air storage vessel for cooling an external environment of the carbon-capture cooling system.

The refrigeration system may comprise: a refrigerant compressor arranged to receive evaporated refrigerant gas from the evaporators and to compress the refrigerant gas; and a refrigerant gas cooler and expander system arranged to receive the compressed refrigerant gas from the refrigerant compressor and to liquify the compressed refrigerant gas to supply the liquid refrigerant to the evaporators.

The refrigerant gas cooler and expander system may comprise: a refrigerant gas cooler arranged to receive the compressed refrigerant gas from the refrigerant compressor and to cool the compressed refrigerant gas; and a plurality of refrigerant turbines, each arranged to receive the cooled compressed refrigerant gas from the refrigerant gas cooler and to expand the compressed refrigerant gas, thereby to liquify the compressed refrigerant gas to supply the liquid refrigerant to a respective one of the evaporators.

The refrigerant gas cooler and expander system may comprise a plurality of refrigerant turbines, each arranged to receive the compressed refrigerant gas from the refrigerant compressor and to cool and expand the compressed refrigerant gas, thereby to liquify the compressed refrigerant gas to supply the liquid refrigerant to a respective one of the evaporators.

The refrigerant turbines may comprise boundary layer turbines.

The carbon-capture cooling system may comprise an electrical generator connected to a respective one of the refrigerant turbines for generating electrical power.

The electrical generator connected to the respective one of the refrigerant turbines may be arranged to generate electrical power for driving the refrigerant compressor.

The electrical generator connected to the refrigerant turbine may be arranged to generate electrical power at 400 Hz.

The carbon-capture cooling system may comprise an air turbine arranged to receive the cooled compressed air from the outlet of the first compressed air storage vessel and to partially expand the cooled compressed air for entry into the second compressed air storage vessel.

The air turbine may comprise a boundary layer turbine.

The carbon-capture cooling system may comprise an electrical generator connected to the air turbine for generating electrical power.

The electrical generator connected to the air turbine may be arranged to generate electrical power for driving the air compressor.

The electrical generator connected to the air turbine may be arranged to generate electrical power at 400 Hz.

The carbon-capture cooling system may comprise a filter for removing contaminants from the cooled compressed air.

The carbon-capture cooling system may comprise one or more carbon dioxide storage vessels arranged to receive the liquidised carbon dioxide.

At least one of the evaporators may be located at least partially inside the respective compressed air storage vessel.

The at least one of the evaporators may be located entirely inside the respective compressed air storage vessel.

The refrigerant may comprise carbon dioxide.

### BRIEF DESCRIPTION OF DRAWINGS

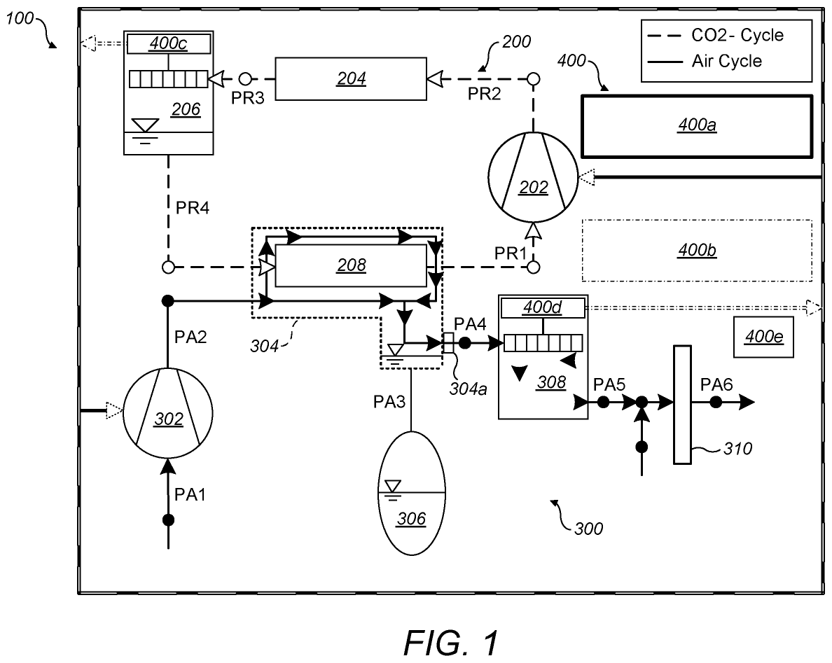

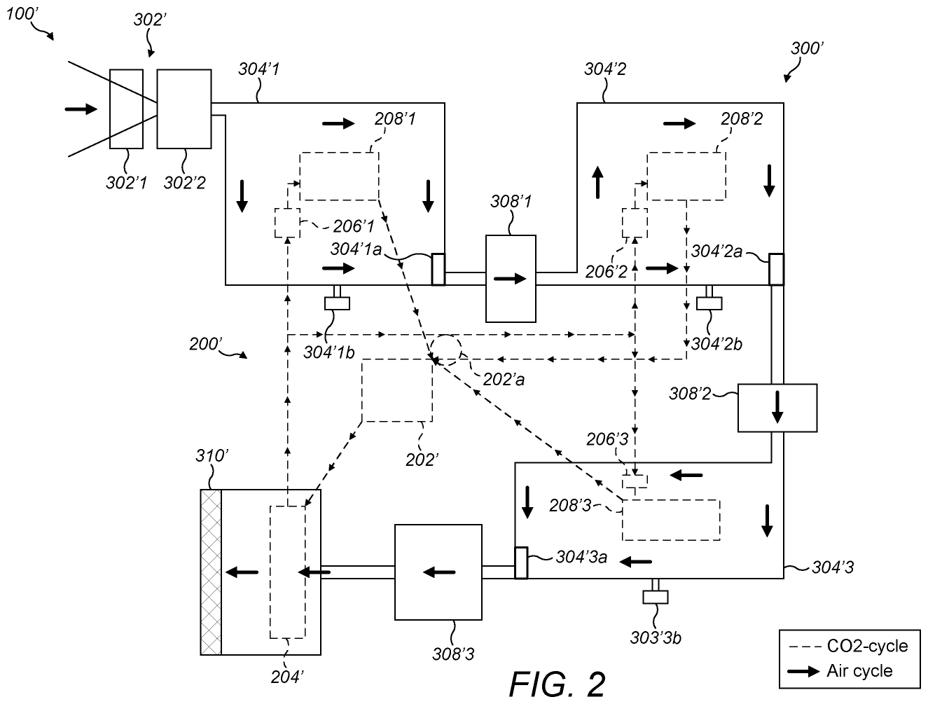

Examples will now be described with reference to accompanying FIGS. 1 and 2, which are schematic representations of carbon-capture cooling systems according to the invention.

### DETAILED DESCRIPTION

Referring to FIG. 1, a carbon-capture cooling system 100 comprises a refrigerant part or system 200 and an air part or system 300. The main elements of the refrigerant part 200 are: a refrigerant compressor 202; a refrigerant gas cooler 204 located downstream of the refrigerant compressor 202; a refrigerant turbine or refrigerant expander 206 located downstream of the refrigerant gas cooler 204; and an evaporator 208 located downstream of the refrigerant turbine 206. These elements are connected together by pipework sections PR1-PR4. The refrigerant part 200 also comprises a working fluid refrigerant. In this example, the working fluid refrigerant is carbon dioxide. It will be understood that as used herein the term “downstream” relates to the direction of movement of the fluid refrigerant through the refrigerant part 200, as will be described later herein.

The main elements of the air part 300 are: an air compressor 302; and a compressed air storage tank 304 located downstream of the air compressor 302 and including an air outlet 304a. In this example, the evaporator 208 is located inside the compressed air storage tank 304. In this example, the air part 300 also comprises a carbon dioxide storage tank 306 connected to the compressed air storage tank 304. In this example, the air part 300 further comprises an air turbine 308 located downstream of the air outlet 304a. In this example, the air part 300 yet further comprises an air filter 310 located downstream of the air turbine 308. These elements are connected together by pipework sections PA1-PA5. It will be understood that as used herein the term “downstream” relates to the direction of movement of air through the air part 300, as will be described later herein.

Also in this example, the carbon-capture cooling system 100 comprises an electrical system 400 including: an electrical generation and supply system 400a; a battery loop storage system 400b; a refrigerant part electrical generator 400c connected to an output shaft of the refrigerant turbine 206; an air part electrical generator 400d connected to an output shaft of the air turbine 308; and a controller 400e.

The operation of the carbon-capture cooling system 100 will now be described. Terms such as cold, warm, hot, low-pressure, and high-pressure, will be used in the description. It will be understood that these are relative terms, used for ease of understanding of the states of the fluids at different stages in the refrigerant part 200 and the air part 300 of the carbon-capture cooling system 100. The description also includes approximate values of temperature, pressure, and mass flow rate, of the fluids. These values are merely exemplary and are in no way limiting of the claimed invention.

Referring to the refrigerant part 200, pipework section PR1 contains a warm, low-pressure gaseous refrigerant, in this example carbon dioxide. The pressure may be about 39 bar and the temperature may be about 5 degrees Celsius.

The warm, low-pressure gaseous refrigerant is received by the refrigerant compressor 202 and is compressed, thereby increasing the pressure and temperature of the gaseous refrigerant to provide a hot, high-pressure gaseous refrigerant. For example, the compressed refrigerant may have a pressure of about 60 to 80 bar and a temperature of about 60 to 90 degrees Celsius. The mass flow rate through the refrigerant compressor 202 may be about 795 kg/hour. In this example, the refrigerant compressor 202 is driven by a mains grid power supply via the electrical generation and supply system 400a.

The hot, high-pressure gaseous refrigerant is fed from the refrigerant compressor 202 to the refrigerant gas cooler 204 via pipework section PR2. The refrigerant gas cooler 204 is a heat exchanger configured to reduce the temperature of the hot, high-pressure gaseous refrigerant, to provide a cool, high-pressure gaseous refrigerant, while keeping the fluid pressure substantially constant. For example, the compressed refrigerant may be cooled to a temperature of about 20 to 30 degrees Celsius and the pressure may be about 60 to 80 bar. The mass flow rate through the refrigerant gas cooler 204 may be about 795 kg/hour. The refrigerant gas cooler 204 may have a cooling capacity of about 47 kW. It will be understood by the skilled person that the refrigerant gas cooler 204 may take any appropriate structural form, for example a double-tube (or tube-and-shell) arrangement for heat transfer to another fluid such as ambient air. Fans may be provided for blowing ambient air over the refrigerant gas cooler 204 to aid heat loss from the compressed refrigerant therein.

The cool, high-pressure gaseous refrigerant is fed from the refrigerant gas cooler 204 to the refrigerant turbine 206 via pipework section PR3. In this example, the refrigerant turbine 206 comprises a boundary layer turbine (BLT), also known as a “Tesla Turbine”. In general, in a boundary layer turbine the gas is driven by a compressor into the turbine and across the surface of the turbine discs. Due to the boundary layer effect, nearby fluid drags on the surface of each disc, transferring energy to the disc and causing it to rotate. As the fluid loses energy it spirals towards the centre of the disc where the exhaust vent is arranged. The amount of work available from a boundary layer turbine is significantly greater than a conventional bladed turbine. This is because energy is transferred across the whole length of a disc spiral, which is substantially further (for a turbine of given size) than is the distance fluid travels as it passes over the blades of a bladed turbine. The greater the rotational velocity, the greater the spiral radius, therefore increasing shaft torque. Furthermore, different from a bladed turbine, performance of the boundary layer turbine is substantially unimpaired by phase changes of the working fluid between gas, vapour, and liquid.

The cool, high-pressure gaseous refrigerant is expanded through the refrigerant turbine 206, causing the refrigerant turbine 206 to be rotated by the force of the fluid flow. The refrigerant part electrical generator 400c, which is coupled to the output shaft of the refrigerant turbine 206, is thereby caused to rotate to produce electrical power. For example, the power output of the refrigerant part electrical generator 400c may be about 5 to 7 kW. The cool, high-pressure gaseous refrigerant changes phase during the expansion through the refrigerant turbine 206, to a vapour and to a cold, low-pressure liquid refrigerant. For example, the cold, low-pressure liquid refrigerant may have a temperature of about −4.5 degrees Celsius and a pressure of about 30 bar. The cold, low-pressure liquid refrigerant is fed from the refrigerant turbine 206 to the evaporator via pipework section PR4. The mass flow rate of the cold, low-pressure liquid refrigerant exiting the refrigerant turbine 206 may be about 795 kg/hour.

Turning now to the air part 300 of the carbon-capture cooling system 100, pipework section PA1 admits ambient air including gaseous carbon dioxide. For example, the ambient air may have a pressure of about 1 bar and a temperature of about 20 degrees Celsius. The air is received by the air compressor 302 and is compressed, thereby increasing the pressure and temperature of the air to provide hot, high-pressure air. For example, the pressure of the compressed air may be about 20 to 30 bar and the temperature may be about 40 degrees Celsius. The mass flow rate through the air compressor 302 may be about 25 kg/hour. In this example, the air compressor is driven by the mains power supply via the electrical generation and supply system 400a.

The hot, high-pressure air is fed from the air compressor 302 to the compressed air storage tank 304 via pipework section PA2. Heat is transferred, from the hot, high-pressure air in the compressed air storage tank 304 to the cold, low-pressure liquid refrigerant in the evaporator 208, thereby causing evaporation (boiling) of the liquid refrigerant. For example, the temperature of the liquid refrigerant may be raised by about 9.5 degrees Celsius to an evaporation (boiling) temperature of about 5 degrees Celsius. Thus, warm, low-pressure gaseous refrigerant (or refrigerant vapour) is returned to pipework section PR1 for entry to the refrigerant compressor 202, as has been described herein above. The mass flow rate of the warm, low-pressure gaseous refrigerant (or refrigerant vapour) exiting the evaporator 208 may be about 25 kg/hour.

The temperature of the compressed, high-pressure air in the compressed air storage tank 304 is therefore reduced to provide cold, high-pressure air therein. For example, the cold, high-pressure air may have a temperature of about −3.2 to −22 degrees Celsius and a pressure of about 18 to 30 bar. As a result of this reduction in temperature, the carbon dioxide contained in the compressed air is liquified. In this example, the liquified carbon dioxide is drained out of the compressed air storage tank 304 into the carbon dioxide storage tank 306, via pipework section PA3.

The pressure of the compressed air in the compressed air storage tank 304 may be maintained at a desired level by control of the air compressor 302, thereby ensuring the correct conditions for liquification of the carbon dioxide. Also, heat generated by the air compressor 302 may be used to remove moisture from the high-pressure air. The compressed air storage tank 304 may be insulated for thermal efficiency.

The table below shows exemplary values, of the air pressure inside the compressed air storage tank 304 and the corresponding temperature in the evaporator 208:

| Pressure, bar | Temperature, degrees Celsius |
|---|---|
| 18 | −22.0 |
| 19 | −21.0 |
| 20 | −19.5 |
| 21 | −17.9 |
| 22 | −16.3 |
| 23 | −14.8 |
| 24 | −13.4 |
| 25 | −12.0 |
| 26 | −10.6 |
| 27 | −9.3 |
| 28 | −8.0 |
| 29 | −6.8 |
| 30 | −5.6 |
| 31 | −4.3 |
| 32 | −3.2 |

The air outlet 304a is controlled to be opened (for example by activation of a valve, or the like) to release the cold, high-pressure air (minus the carbon dioxide that has been removed therefrom) from the compressed air storage tank 304. The cold, high-pressure air is fed from the air outlet 304a to the air turbine 308 via pipework section PA4. In this example, the air turbine 308 comprises a boundary layer turbine (BLT), the operating principle of which has already been discussed herein above.

The cold, high-pressure air is received by the air turbine 308 and is expanded therethrough, causing the air turbine 308 to be rotated by the force of the air flow. The air part electrical generator 400d, which is coupled to the output shaft of the air turbine 308, is thereby caused to rotate to produce electrical power. For example, the power output of the air part electrical generator 400d may be about 3 to 5 kW. The mass flow rate through the air turbine 308 may be about 25 kg/hour. The expansion of the cold, high-pressure air through the air turbine 308 produces cold, low-pressure air. For example, the cold, low-pressure air may have a temperature of about −2 to −15 degrees Celsius and a pressure of up to about 3 bar.

The cold, low-pressure air is fed from the air turbine 308 to the air filter 310 via pipework section PA5. The air is cleaned of any contaminants, e.g. dust particles, biological pathogens including bacteria and viruses, and the like, as it flows through the air filter 310.

Having passed through the air filter 310, the cold, low-pressure air enters the pipework section PA6, from which it exits the carbon-capture cooling system 100 into the external environment. The temperature of the exit air may be about −2 to −12 degrees Celsius. Examples of external environment include, but are not limited to, a room in a building, a storage area such as a food storage area, or an outdoor environment such as an urban street. The temperature of the environment is greater than the temperature of the cold, low-pressure air leaving the carbon-capture cooling system 100. Accordingly, the colder air has a cooling effect on the warmer environment.

In this example, pipework section PA5 includes an optional air inlet for allowing ambient air into pipework section PA5. Since the ambient air has a higher temperature than does the cold, low-pressure air in pipework section PA5, the ambient air warms the cold, low-pressure air in pipework section PA5. The air inlet may be controlled to admit a desired amount of ambient air into pipework section PA5, depending upon the temperature of the ambient air. In this way, the temperature of the cold, low-pressure air in pipework section PA5, that is eventually expelled into the environment, may be controlled, for example to regulate the temperature of a room in a building.

In the above-described example, the refrigerant fluid is circulated through the refrigerant part 200 of the carbon-capture cooling system 100 in a closed refrigeration cycle. Conversely, the air part 300 operates in an open cycle, with warm, ambient air entering the air part 300 and cold air leaving the air part 300.

The tables below summarise the state of each of the two working fluids of the carbon-capture cooling system 100 through the stages of their respective cycles:

Refrigerant part 200

| Part of Cycle | State of Refrigerant |
|---|---|
| Entry to refrigerant compressor 202 | Warm, low-pressure gas |
| Entry to refrigerant gas cooler 204 | Hot, high-pressure gas |
| Entry to refrigerant turbine 206 | Cool, high-pressure gas |
| Entry to evaporator 208 | Cold, low-pressure liquid |

Air part 300

| Part of Cycle | State of Air |
|---|---|
| Entry to air compressor 302 | Ambient (atmospheric conditions) |
| Entry to compressed air | Hot, high-pressure gas |
| storage tank 304 | |
| Entry to air turbine 308 | Cold, high-pressure gas |
| Exit to external environment | Cold, low-pressure gas |

In the above-described example, each of the refrigerant part electrical generator 400c and the air part electrical generator 400d provides an electrical power output. The controller 400e may control this electrical power to be fed back to the mains grid via the electrical generation and supply system 400a, or to contribute to driving one or both of the refrigerant compressor 202 and the air compressor 302, or to be stored by the battery loop storage system 400b for later use, or any combination of these. Generation may be at 400 Hz, which may be converted to 50/60 Hz.

The refrigerant gas cooler 204 may be located in the airstream of the cool air leaving the pipework section PA6 in order to enhance cooling performance.

While in the above-described example the air system 300 comprises an air filter 310, in other examples the air filter 310 is omitted. In yet other examples, the air filter 310 is located upstream (before) the air turbine 308, rather than downstream of the air turbine 308.

While in the above-described example the air system 300 comprises an air turbine 308, in other examples the air turbine 308 is omitted. In such examples, the cold, high-pressure air may simply exit the air outlet 304a of the compressed air storage tank 304 into the external environment. Or, the cold, high-pressure air may exit the air outlet 304a and then be passed through the air filter 310 before entering the external environment.

While in the above-described example the refrigerant part 200 uses carbon dioxide as the working fluid, in other examples different refrigerant fluids are used. Examples include, but are not limited to, ammonia, difluoromethane, and 1,1,1,2-tetrafluoroethane.

While in the above-described example the evaporator 208 is located inside the compressed air storage tank 304, in other examples the evaporator 208 is located outside the compressed air storage tank 304, or is located partially inside and partially outside the compressed air storage tank 304. All such arrangements are within the scope of the claimed invention, provided that the evaporator 208 is arranged to extract heat from the compressed air in the compressed air storage tank 304 by evaporation of the liquid refrigerant, thereby to cool the compressed air to liquidise the gaseous carbon dioxide for capture.

While in the above-described example the refrigerant part 200 comprises a refrigerant gas cooler 204, and a refrigerant turbine 206 located downstream of the refrigerant gas cooler 204, in other examples the refrigerant gas cooler 204 and the refrigerant turbine 206 are omitted. In such examples, the refrigerant part 200 comprises a condenser (i.e. in place of the refrigerant gas cooler 204) and an expansion valve (or other throttling device) located downstream of the condenser (i.e. in place of the refrigerant turbine 206). In these examples, the cooled fluid refrigerant leaves the condenser and enters the expansion valve as a high-pressure liquid, and exits the expansion valve as a cold, low-pressure liquid for entry to the evaporator 208. It will therefore be understood that, in these examples, the refrigerant part 200 is essentially a conventional refrigeration system comprising a compressor, a condenser, an expansion valve, and an evaporator.

While in the above-described example the refrigerant part 200 comprises a refrigerant gas cooler 204, and a refrigerant turbine 206 located downstream of the refrigerant gas cooler 204, in other examples the refrigerant gas cooler 204 is omitted, along with pipework section PR3. In such examples, the refrigerant turbine 206 is arranged to receive the hot, high-pressure gaseous refrigerant from the refrigerant compressor 202 via pipework section PR2. The hot, high-pressure gaseous refrigerant is expanded through the refrigerant turbine 206, causing the refrigerant turbine 206 to be rotated by the force of the fluid flow. In this way, heat and pressure are given up by the hot, high-pressure gaseous refrigerant to drive the turbine to produce useful work, i.e. to drive the refrigerant part electrical generator 400c. The hot, high-pressure gaseous refrigerant changes phase during the expansion through the refrigerant turbine 206, to a vapour and to a cold, low-pressure liquid refrigerant. The cold, low-pressure liquid refrigerant is fed from the refrigerant turbine 206 to the evaporator via pipework section PR4, as has been described herein above. Thus, in these examples, the refrigerant turbine 206 or “single-expander” receives a hot, high-pressure gaseous refrigerant and expels a cold, low-pressure liquid refrigerant for use in the evaporator. The refrigerant turbine 206 is therefore a single device which efficiently performs the functions of both of a condenser and an expansion valve of a conventional refrigeration system.

While in the above-described example the liquified carbon dioxide is drained into the carbon dioxide storage tank 306, in other examples the carbon dioxide storage tank 306 is omitted. In such examples, the liquified carbon dioxide may be directed (drained or pumped) out of the carbon-capture cooling system 100 for (immediate or later) use in an industrial process, such as carbonation of beverages.

While in the above-described example the elements of the refrigerant part 200 and the air part 300 of the carbon-capture cooling system 100 are connected together by pipework sections PR1-PR4, PA1-PA6, in other examples at least some of the pipework sections are omitted and at least some of the elements are connected to each other directly.

While in the above-described example the refrigerant compressor 202 and the air compressor 302 are driven by the mains power supply via the electrical generation and supply system 400a, in other examples some other kind of drive means is used. For example, one or both of the refrigerant compressor 202 and the air compressor may be arranged to be driven by an output shaft of an engine.

In an example, an additional or “first stage” air compressor (not shown in FIG. 1) is located upstream of the air compressor 302. The first stage air compressor is a low pressure compressor, for example operating at around 3 bar, for removing water and/or water vapour from the air received from pipework section PA1. The first stage air compressor may be arranged to be driven by the mains power supply via the electrical generation and supply system 400a, or by some other means such as an engine. The dried air is then supplied to and compressed by the air compressor 302 or “second stage” compressor, for example to around 20 to 30 bar.

While in the above-described example the carbon-capture cooling system 100 comprises a single compressed air storage tank 304 and a single evaporator 208, in other examples there is provided a plurality of air storage tanks and a plurality of evaporators. Such an example will now be described with reference to FIG. 2.

As shown in FIG. 2, a carbon-capture cooling system 100′ comprises a refrigerant part or system 200′ and an air part or system 300′. The main elements of the refrigerant part 200′ are: a refrigerant compressor 202′ comprising an intake 202′a; a refrigerant gas cooler 204′ (or condenser, as has been discussed herein above) located downstream of the refrigerant compressor 202′; a first refrigerant turbine or refrigerant expander 206′1 located downstream of the refrigerant gas cooler 204′; a first evaporator 208′1 located downstream of the first refrigerant turbine 206′1 and arranged within a first air storage tank 304′1, the first evaporator 208′1 being upstream of and connected to the intake 202′a of the refrigerant compressor 202′; a second refrigerant turbine or refrigerant expander 206′2 located downstream of the refrigerant gas cooler 204′; a second evaporator 208′2 located downstream of the second refrigerant turbine 206′2 and arranged within a second air storage tank 304′2, the second evaporator 208′2 being upstream of and connected to the intake 202′a of the refrigerant compressor 202′; a third refrigerant turbine or refrigerant expander 206′3 located downstream of the refrigerant gas cooler 204′; and a third evaporator 208′3 located downstream of the third refrigerant turbine 206′3 and arranged within a third air storage tank 304′3, the third evaporator 208′3 being upstream of and connected to the intake 202′a of the refrigerant compressor 202′. The refrigerant part 200′ also comprises a working fluid refrigerant. In this example, the working fluid refrigerant is carbon dioxide. It will be understood that as used herein the terms “downstream” and “upstream” relate to the direction of movement of the fluid refrigerant through the refrigerant part 200′.

The main elements of the air part 300′ are: an air compressor 302′, in this example comprising a first, low pressure stage 302′1 and a second, high pressure stage 302′2; the first compressed air storage tank 304′1, located downstream of the air compressor 302′ and including a first air outlet 304′1a and a first CO2 drain port 304′1b; a first air turbine 308′1 located downstream of the first air outlet 304′1a; the second compressed air storage tank 304′2, located downstream of the first air turbine 308′1 and including a second air outlet 304′2a and a second CO2 drain port 304′2b; a second air turbine 308′2 located downstream of the second air outlet 304′2a; the third compressed air storage tank 304′3, located downstream of the second air turbine 308′2 and including a third air outlet 304′3a and a third CO2 drain port 304′3b; a third air turbine 308′3 located downstream of the third air outlet 304′3a; and an air filter 310′ located downstream of the third air turbine 308′3 and leading to the external environment.

It will be understood that as used herein the terms “downstream” and “upstream” relate to the direction of movement of the fluid refrigerant through the refrigerant part 200 and the air through the air part 300.

It will be understood that the elements of the carbon-capture cooling system 100′ are connected together by pipework sections (not labelled in FIG. 2) in the manner described herein above. Alternatively, at least some of the pipework sections are omitted and at least some of the elements are connected to each other directly.

The operation of the carbon-capture cooling system 100′ of FIG. 2 is broadly similar to that of the carbon-capture cooling system 100 of FIG. 1 as described herein above, except that in the carbon-capture cooling system 100′ of FIG. 2 the flow of the fluid refrigerant leaving the refrigerant gas cooler 204′ is divided so as to feed each of the first, second and third refrigerant expanders 206′1, 206′2, 206′3 and thereby the first, second and third evaporators 208′1, 208′2, 208′3. Thus, the first, second and third evaporators 208′1, 208′2, 208′3 are arranged in parallel, and they each direct warm, low-pressure gaseous refrigerant to the intake 202′a of the refrigerant compressor 202′. Furthermore, the first, second and third air storage tanks 304′1, 304′2 and 304′3, and the first, second and third air turbines 308′1, 308′2, 308′3, are arranged in series.

The refrigerant compressor 202′ and/or the air compressor 302′ may be driven by a mains power supply via an electrical generation and supply system, or by some other suitable drive means such as an output shaft of an engine, as has been described herein above. By way of example, the pressure in the first air storage tank 304′1 may be about 90 bar, while the second air storage tank 304′2 may be at a ratio of 4.48 or 3.52 or other, depending on application. The range may be 90 bar in the first air storage tank 304′1, 20 bar in the second air storage tank 304′2, and 4.46 bar in the third air storage tank 304′3. Or, 90 bar to 60 bar to 30 bar with a 30 bar drop through each turbine system.

The configuration of the carbon-capture cooling system 100′ may vary from the described example of FIG. 2. The variations may be as described herein above with respect to the carbon-capture cooling system 100′ of FIG. 1. All such practicable configurations are envisaged and are within the scope of the claimed invention, provided that the carbon-capture cooling system 100′ includes more than one compressed air storage tank and more than one evaporator.

It should be understood that the invention has been described in relation to its preferred embodiments and may be modified in many different ways without departing from the scope of the invention as defined by the accompanying claims.

1. A carbon-capture cooling system, comprising:
a refrigeration system comprising an evaporator and arranged to supply a liquid refrigerant to the evaporator,
an air compressor arranged to compress air including gaseous carbon dioxide; and
a compressed air storage vessel arranged to receive the compressed air from the air compressor and comprising an air outlet;
wherein:
the evaporator is arranged to extract heat from the compressed air in the compressed air storage vessel by evaporation of the liquid refrigerant, thereby to cool the compressed air to liquidise the gaseous carbon dioxide for capture; and
the air outlet is arranged to release the cooled compressed air from the compressed air storage vessel for cooling an external environment of the carbon-capture cooling system.

2. The carbon-capture cooling system according to claim 1, wherein the refrigeration system comprises:
a refrigerant compressor arranged to receive evaporated refrigerant gas from the evaporator and to compress the refrigerant gas; and
a refrigerant gas cooler and expander system arranged to receive the compressed refrigerant gas from the refrigerant compressor and to liquify the compressed refrigerant gas to supply the liquid refrigerant to the evaporator.

3. The carbon-capture cooling system according to claim 2, wherein the refrigerant gas cooler and expander system comprises:
a refrigerant gas cooler arranged to receive the compressed refrigerant gas from the refrigerant compressor and to cool the compressed refrigerant gas; and
a refrigerant turbine arranged to receive the cooled compressed refrigerant gas from the refrigerant gas cooler and to expand the compressed refrigerant gas, thereby to liquify the compressed refrigerant gas to supply the liquid refrigerant to the evaporator.

4. The carbon-capture cooling system according to claim 2,
wherein the refrigerant gas cooler and expander system comprises a refrigerant turbine arranged to receive the compressed refrigerant gas from the refrigerant compressor and to cool and expand the compressed refrigerant gas, thereby to liquify the compressed refrigerant gas to supply the liquid refrigerant to the evaporator.

5. The carbon-capture cooling system according to claim 3,
wherein the refrigerant turbine comprises a boundary layer turbine.

6. The carbon-capture cooling system according to claim 3, comprising an electrical generator connected to the refrigerant turbine for generating electrical power.

7. The carbon-capture cooling system according to claim 6,
wherein the electrical generator connected to the refrigerant turbine is arranged to generate electrical power for driving the refrigerant compressor.

8. The carbon-capture cooling system according to claim 6,
wherein the electrical generator connected to the refrigerant turbine is arranged to generate electrical power at 400 Hz.

9. The carbon-capture cooling system according to claim 1, comprising an air turbine arranged to receive the cooled compressed air from the outlet of the compressed air storage vessel and to expand the cooled compressed air for cooling the external environment of the carbon-capture cooling system.

10. The carbon-capture cooling system according to claim 9,
wherein the air turbine comprises a boundary layer turbine.

11. The carbon-capture cooling system according to claim 9, comprising an electrical generator connected to the air turbine for generating electrical power.

12. The carbon-capture cooling system according to claim 11,
wherein the electrical generator connected to the air turbine is arranged to generate electrical power for driving the air compressor.

13. The carbon-capture cooling system according to claim 11,
wherein the electrical generator connected to the air turbine is arranged to generate electrical power at 400 Hz.

14. The carbon-capture cooling system according to claim 1, comprising a filter for removing contaminants from the cooled compressed air.

15. The carbon-capture cooling system according to claim 1, comprising a carbon dioxide storage vessel arranged to receive the liquidised carbon dioxide.

16. The carbon-capture cooling system according to claim 1,
wherein the evaporator is located at least partially inside the compressed air storage vessel.

17. The carbon-capture cooling system according to claim 16,
wherein the evaporator is located entirely inside the compressed air storage vessel.

18. The carbon-capture cooling system according to claim 1,
wherein the refrigerant comprises carbon dioxide.

19. A carbon-capture cooling system, comprising:
a refrigeration system comprising a plurality of evaporators and arranged to supply a liquid refrigerant to the evaporators;
an air compressor arranged to compress air including gaseous carbon dioxide; and
a plurality of compressed air storage vessels each comprising an air outlet;
wherein:
a first one of the compressed air storage vessels is arranged to receive the compressed air from the air compressor;
a second one of the compressed air storage vessels is arranged to receive the compressed air from the air outlet of the first one of the compressed air storage vessels;
a first one of the evaporators is arranged to extract heat from the compressed air in the first one of the compressed air storage vessels, and the second one of the evaporators is arranged to extract heat from the compressed air in the second one of the compressed air storage vessels, by evaporation of the liquid refrigerant, thereby to cool the compressed air to liquidise the gaseous carbon dioxide for capture; and
the air outlet of the second compressed air storage vessel, or of a further compressed air storage vessel which is located downstream of the second compressed air storage vessel, is arranged to release the cooled compressed air from the second or further compressed air storage vessel for cooling an external environment of the carbon-capture cooling system.

20. The carbon-capture cooling system according to claim 19, wherein the refrigeration system comprises:
a refrigerant compressor arranged to receive evaporated refrigerant gas from the evaporators and to compress the refrigerant gas; and
a refrigerant gas cooler and expander system arranged to receive the compressed refrigerant gas from the refrigerant compressor and to liquify the compressed refrigerant gas to supply the liquid refrigerant to the evaporators.

21-36. (canceled)
